(19) United States
(12) Patent Application Publication
(10) Pub. No.: US 2014/0035528 A1
(43) Pub. Date: Feb. 6, 2014

(54) APPLIANCE AND METHOD FOR RECHARGING BATTERIES OF ELECTRIC VEHICLES OR THE LIKE

(71) Applicants: Giuseppe Simonazzi, Reggio Emilia (IT); Cesare Lasagni, Reggio Emilia (IT)

(72) Inventors: Giuseppe Simonazzi, Reggio Emilia (IT); Cesare Lasagni, Reggio Emilia (IT)

(73) Assignee: META SYSTEM S.P.A., Reggio Emilia (IT)

(21) Appl. No.: 14/003,947

(22) PCT Filed: Mar. 6, 2012
(86) PCT No.: PCT/IB2012/000406

§ 371 Date: Oct. 4, 2013

(30) Foreign Application Priority Data
Mar. 9, 2011 (IT) MO2011A000054

(51) Int. Cl. B60L 11/18

(52) U.S. Cl. CPC B60L 11/1844
USPC 320/109; 320/137

(57) ABSTRACT

The appliance (1) for recharging batteries of electric vehicles or the like includes:
a first electric connection element (2) to an electric supply mains (3);
a second electric connection element (4) to an electric vehicle (5) or the like;
a power supply unit (9) associated with the first and second electric connection element (2, 4) and suitable for converting the electric energy absorbed by the supply mains (3) into electric energy deliverable to the electric vehicle (5);
a checking unit (11) of the available electric power on the supply mains (3), determined according to the maximum electric power deliverable from the supply mains (3) and to the electric power absorbed by possible electric units (12) connected to the supply mains (3);
a regulation unit (14) of the electric power delivered by the power supply unit to the vehicle (5) according to the available electric power.

### TECHNICAL FIELD

The present invention relates to an appliance and method for recharging batteries of electric vehicles or the like.

### BACKGROUND ART

It is known that electric vehicles run on rechargeable power batteries which can be of different types depending on the type of technology used and on required performances.

The batteries of electric vehicles do however have a limited autonomy and must be periodically recharged.

In this respect, the use of specific battery chargers is known and common, connected to the conventional power supply mains and usable, for example, directly by the users of the vehicles inside their homes.

In this case, the recharge time is mainly determined by the current transmittable by the supply mains connection.

The power normally available by connecting up to a conventional domestic power socket varies between 1.5 kW (in countries with a power voltage of 110V) and 3-6kW (in countries with power voltage of 240 V).

Generally speaking, the maximum power dispensable by a domestic supply mains is defined at the time of executing the contract with the utility company and, in the event of such maximum power supply value being exceeded, commonly provided is either the interruption of the power supply to the unit (e.g., by means of any specific limiting device fitted in the meter device) or the application of a higher tariff.

The use of a battery charger for electric vehicles furthermore requires all or a major part of the available power (generally between 2.5 and 3 kW) from the mains.

This therefore results in the use of a battery charger connected to the conventional domestic supply mains sometimes not being simple and, in any case, tied to the use of other electrical units (washing machine, dishwasher or the like) inside the home.

In fact, so as not to exceed the above maximum available power value, the recharge of the electric vehicle by means of the battery charger is normally done at night or, in any case, when other electrical units do not absorb power from the domestic supply mains.

### DESCRIPTION OF THE INVENTION

The main aim of the present invention is to provide an appliance and method for recharging batteries of electric vehicles or the like which can be connected to the conventional electric supply mains at any time, quite apart from whether or not there are other electric units connected to the mains.

Another object of the present invention is to provide an appliance and method for recharging batteries of electric vehicles or the like that allows overcoming the mentioned drawbacks of the state of the art in the ambit of a simple, rational, easy and effective to use as well as low cost solution.

The above mentioned objects are achieved by the present appliance for recharging batteries of electric vehicles or the like, comprising:
first electric connection means to an electric supply mains;
second electric connection means to at least an electric vehicle or the like;
power supply means associated with said first and second electric connection means and suitable for converting the electric energy absorbed by said supply mains into electric energy deliverable to said electric vehicle;

characterised by the fact that it comprises:
at least a checking unit of the available electric power on said supply mains, determined according to the maximum electric power deliverable from said supply mains and to the electric power absorbed by possible electric units connected to said supply mains;
at least a regulation unit of the electric power delivered by said supply means to said vehicle according to said available electric power.

The above mentioned objects are also achieved by the present method for recharging batteries of electric vehicles or the like, characterised by the fact that it comprises the following phases:
at least a checking phase of the available electric power on an electric supply mains, determined according to the maximum electric power deliverable from said supply mains and to the electric power absorbed by possible electric units connected to said supply mains;
at least a regulation phase of the electric power delivered to at least an electric vehicle or the like according to said available electric power.

### BRIEF DESCRIPTION OF THE DRAWINGS

Other characteristics and advantages of the present invention will become more evident from the description of a preferred, but not sole, embodiment of an appliance and method for recharging batteries of electric vehicles or the like, illustrated purely as an example but not limited to the annexed drawings in which:

FIG. 1 is a general functional diagram of the appliance according to the invention.

### EMBODIMENTS OF THE INVENTION

With particular reference to such illustrations, globally indicated by 1 is an appliance for recharging batteries of electric vehicles or the like.

Preferably, the appliance 1 is connectable to the conventional domestic electric supply mains and is usable, e.g., directly by the users of electric vehicles inside their own homes.

Connecting the appliance 1 to different supply mains or supply devices and its use in different ambits cannot however be ruled out.

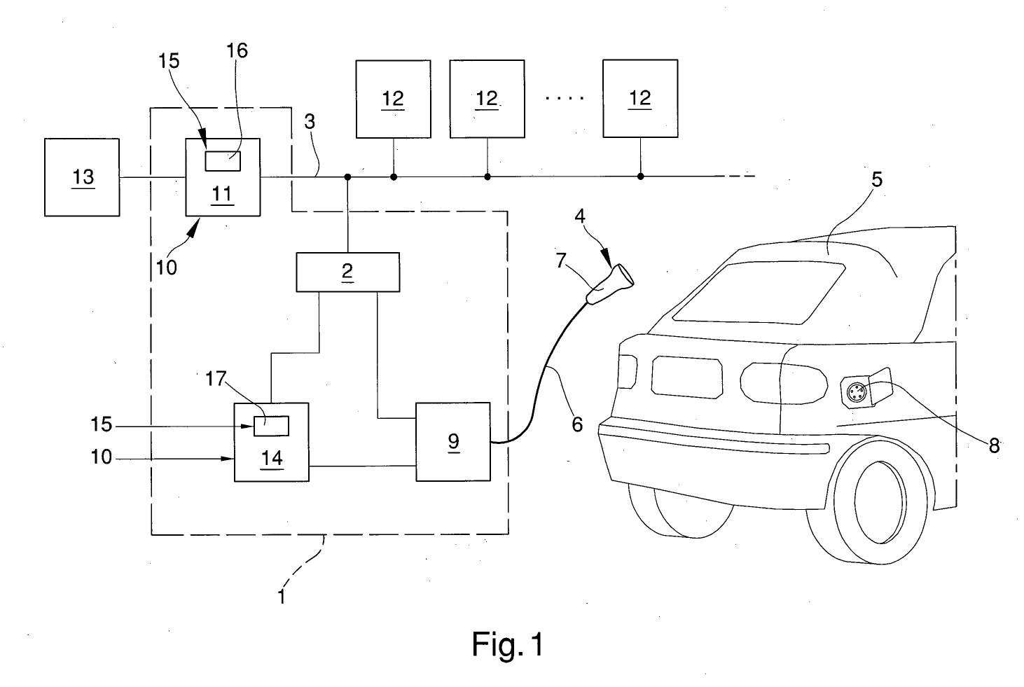

The appliance 1 comprises first electric connection means 2 suitable for being connected to an electric supply mains, globally indicated by 3 in FIG. 1.

The first electric connection means 2 can be made up, e.g., of a suitable connector connectable to a conventional power socket of the supply mains 3.

The appliance 1 also comprises second electric connection means 4 suitable for being connected to an electrically propelled vehicle 5.

The second electric connection means 4 can be made up, e.g., of a specific cable 6 and of a connector 7 of conventional type connectable to a complementary power socket 8 on the vehicle 5.

The appliance 1 comprises power supply means 9 connected to the first and to the second electric connection means 2 and 4 and suitable for converting the energy absorbed from the supply mains 3 into electricity dispensable to the vehicle 5.

In particular, the power supply means 9 can comprise an AC/DC converter device suitable for converting the alternate current dispensed by the power supply mains 3 into direct current usable for recharging the battery of the vehicle 5.

Advantageously, the appliance 1 comprises management and control means 10 associated with the supply mains 3 and with power supply means 9.

In particular, the management and control means 10 of the appliance 1 comprise a checking unit 11 suitable for checking the electricity available on the supply mains 3, determined according to the maximum electricity dispensable by the power mains itself and by the electricity absorbed by any electric units 12 connected to the supply mains itself.

Examples of electric units 12 connected to the domestic supply mains 3 can be: a dishwasher, a washing machine, an electric convector heater or the like.

It is pointed out that by the term “maximum dispensable power” is meant the maximum amount of power dispensable by a domestic supply mains (and therefore the maximum power absorbable by the various electric units 12 present and operating inside a home) which is generally speaking defined at the time of executing the contract between a user and a utility company.

Commonly speaking, in the case of such maximum power value being exceeded, the interruption is provided of the power supply to the unit (e.g., by means of any specific limiting device fitted in the meter device) or the application of a higher tariff.

Preferably, the electricity available on the supply mains 3 in a determinate moment is equal to the difference between the maximum electricity dispensable by the supply mains itself and the electricity absorbed by the other electric units 12.

Usefully, the checking unit 11 is made up of a central unit associated with a meter device 13, of the type e.g. of a conventional meter device used in private homes and suitable for measuring the electricity dispensed by the supply mains 3.

Advantageously, the appliance 1 comprises a regulation unit 14 suitable for regulating the power dispensed by the power supply means 9 to the vehicle 5 according to the above electricity available on the supply mains 3.

Preferably, the dispensed electricity is equal to the available electricity.

This way, the maximum power available on the supply mains 3 is usable for recharging the vehicle 5 by means of the appliance 1 without exceeding the maximum power dispensable by the supply mains itself.

This allows avoiding undesired interruptions of the supply of electricity or the application of higher tariffs for the energy supplied over and above such maximum dispensable power.

Usefully, the management and control means 10 comprise means for transmitting/receiving data between the checking unit 11 and the regulation unit 14, generally indicated in the illustration with the reference 15.

The checking unit 11 and the regulation unit 14 are in fact located preferably at different points inside the building (home, etc.).

The checking unit 11 is connected to the meter device 13 and is preferably located close to it.

The regulation unit 14 is suitable for controlling the power supply means 9 and preferably is located in the proximity of the vehicle 5.

Different embodiments of the appliance 1 cannot however be ruled out wherein both the checking unit 11 and the regulation unit 14 are made inside a single container.

With reference to the particular embodiment of the appliance 1 shown in FIG. 1, the checking unit 11 is associated with the regulation unit 14 through the first electric connection means 2 and the supply mains 3.

Always with reference to the particular embodiment shown in FIG. 1, the transmitting/receiving means 15 comprise a first transmitting/receiving device 16 on the checking unit 11, suitable for transmitting/receiving data to/from the regulation unit 14, by means of the so-called conveyed wave technology and directly on the supply mains 3.

The transmitting/receiving means 15 also comprise a second transmitting/receiving device 17 on the regulation unit 14, suitable for transmitting/receiving data to/from the checking unit 11, by means of the so-called conveyed wave technology and directly on the supply mains 3.

Different transmitting/receiving means 15 and the use of different technologies for transmitting/receiving data between the checking unit 11 and the regulation unit 14 cannot however be ruled out.

Alternatively, for example, the transmitting/receiving means 15 can comprise a first transmitting/receiving device on the checking unit 11, suitable for transmitting/receiving data to/from the regulation unit 14, by means of a so-called wireless technology (e.g., by radio frequency by means of Wi-Fi, Bluetooth or other communication standard).

In this case, the transmitting/receiving means 15 also comprise a second transmitting/receiving device on the regulation unit 14, suitable for transmitting/receiving data to/from the checking unit 11, by means of the so-called wireless technology (e.g., by radio frequency by means of Wi-Fi, Bluetooth or other communication standard).

The method for recharging batteries of electric vehicles or the like according to the invention is described here below.

The method according to the invention comprises a phase of checking the electricity available on the power supply mains.

In particular, such checking phase is performed by the checking unit 11 which determines the electricity available according to the maximum power dispensable by the supply mains 3 and according to the electricity absorbed by any electric units 12 connected to the supply mains.

The electricity absorbed by the other electric units 12 is detected directly by the meter device 13, to which the checking unit 11 is connected.

The method according to the invention also comprises a phase of regulation of the electricity dispensed through the power supply means 9 and the second electric connection means 4 to an electrically-propelled vehicle 5.

In particular, this regulation phase is performed by the regulation unit 14 which determines the electricity dispensed to the vehicle 5 according to the electricity available on the supply mains 3.

Preferably, the electricity available on the supply mains 3 in a determinate moment is equal to the difference between the maximum electricity dispensable by the supply mains itself and the electricity absorbed by other electric units 12.

Preferably, the dispensed electricity is equal to the available electricity.

This way, the maximum power available on the supply mains 3 is usable to recharge the vehicle 5 by means of the appliance 1 without exceeding the maximum power dispensable by the supply mains itself, during the entire period of use of the appliance 1 and quite apart from the number and type of any other electric units 12 connected to the supply mains 3.

It has in practice been ascertained how the described invention achieves the proposed objects.

In particular, the fact is underlined that the appliance and the method according to the invention permit recharging batteries for electric vehicles or the like by means of the conventional supply mains at any time, quite apart from whether or not there are other electric units connected to the mains.

1-11. (canceled)

12. Appliance (1) for recharging batteries of electric vehicles or the like, comprising:
first electric connection means (2) to an electric supply mains (3);
second electric connection means (4) to at least an electric vehicle (5) or the like;
power supply means (9) associated with said first and second electric connection means (2, 4) and suitable for converting the electric energy absorbed by said supply mains (3) into electric energy deliverable to said electric vehicle (5);
wherein said appliance (1) comprises:
at least a checking unit (11) of the available electric power on said supply mains (3), determined according to the maximum electric power deliverable from said supply mains (3) and to the electric power absorbed by possible electric units (12) connected to said supply mains (3);
at least a regulation unit (14) of the electric power delivered by said supply means to said vehicle (5) according to said available electric power.

13. Appliance (1) according to the claim 12, wherein said available electric power is equal to the difference between said maximum deliverable electric power and said absorbed electric power.

14. Appliance (1) according to claim 12, wherein said electric power delivered is equal to said available electric power.

15. Appliance (1) according to claim 12, wherein said checking unit (11) is associated with at least a meter device (13) of the electric energy delivered by said supply mains (3).

16. Appliance (1) according to claim 12, wherein said appliance (1) comprises transmitting/receiving means (15) suitable for transmitting/receiving data between said checking unit (11) and said regulation unit (14).

17. Appliance (1) according to claim 12, wherein said checking unit (11) is associated with said regulation unit (14) through said supply mains (3).

18. Appliance (1) according to the claim 16, wherein said transmitting/receiving means (15) comprise at least a conveyed wave transmitting/receiving device (16, 17) through said supply mains (3).

19. Appliance (1) according to the claim 16, wherein said transmitting/receiving means (15) comprise at least a wireless transmitting/receiving device.

20. Method for recharging batteries of electric vehicles or the like, wherein said method comprises the following phases:
at least a checking phase of the available electric power on an electric supply mains (3), determined according to the maximum electric power deliverable from said supply mains (3) and to the electric power absorbed by possible electric units (12) connected to said supply mains (3);
at least a regulation phase of the electric power delivered to at least an electric vehicle (5) or the like according to said available electric power.

21. Method (1) according to the claim 20, wherein said available electric power is equal to the difference between said maximum electric power deliverable and said absorbed electric power.

22. Method (1) according to claim 20, wherein said delivered electric power is equal to said available electric power.
